(19) United States
(12) Patent Application Publication
(10) Pub. No.: US 2008/0055464 A1
(43) Pub. Date: Mar. 6, 2008

(54) Method of automatically selecting resolution and video receiving apparatus to use the same

(75) Inventor: Ik-kyung Shin, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/706,255

(22) Filed: Feb. 15, 2007

(30) Foreign Application Priority Data
Aug. 31, 2006 (KR) 2006-83641

(51) Int. Cl. H04N 7/01

(52) U.S. Cl. 348/441

(57) ABSTRACT

A method of automatically selecting a resolution and a video receiving apparatus to use the same. The method may include determining whether an external display apparatus is connected through a digital video output terminal, and automatically adjusting the resolution of a digital video signal outputted through the digital video output terminal if it is determined that the external apparatus is connected. The resolution may be 1080i or 1080p and the digital video output terminal may be an HDMI terminal connected (directly or indirectly) to a compatible video display apparatus.

### CROSS-REFERENCE TO RELATED APPLICATIONS

This application claims priority under 35 U.S.C. § 119 (a) of Korean Patent Application No. 10-2006-0083641, filed on Aug. 31, 2006, in the Korean Intellectual Property Office, the disclosure of which is incorporated herein by reference in its entirety.

### BACKGROUND OF THE INVENTION

1. Field of the Invention

The present general inventive concept relates to a method of automatically selecting a resolution and a video receiving apparatus to use the same. More particularly, the present general inventive concept relates to a method of automatically selecting a resolution, in which the resolution of the received video signal is selected so as to have the highest image quality, and a video receiving apparatus to use the same.

2. Description of the Related Art

Video display apparatuses display video received via antennas, and typically used with set-top-boxes. Set-top-boxes are used to transmit digital type video signals received from antennas via tuners to video display apparatuses such as TVs or monitors. The TVs display the video corresponding to the video signals received from the set-top-boxes.

Recently, high definition (HD) or standard definition (SD) class video signals have become available. Accordingly, video receiving apparatuses can output received video signals at various resolution levels. The resolutions corresponding to the HD class video signals, which can be outputted, are 1080i (1920×1080), 1080p (1920×1080), and 720p (1280×720), and the resolutions corresponding to the SD class video signals are 480p (704×480) and 480i (640×480). The 1080i designation refers to 1080 lines transmitted as two 540-line fields of “odd” and “even” lines, to be interlaced into one picture. The 1080p designation refers to 1080 lines progressively scanned to display one picture. The 720p designation refers to 720 lines progressively scanned to display one picture.

However, in conventional video receiving apparatuses, a user has to select the desired resolution in order to apply the selected resolution level (e.g., among various resolution levels) to the received video signals. The conventional video receiving apparatuses are used to convert and to output the received HD or SD class video signals so as to be displayed according to the resolution selected by the user.

Specifically, conventional video receiving apparatuses provide remote controllers or physical interfaces on the main body through which the resolution can be selected, or provide graphic interfaces having menu screens through which the resolution can be selected. Accordingly, the user can select the desired resolution. When the user selects the desired resolution through the provided interfaces, the video receiving apparatuses convert the received video signals according to the selected resolution and the converted signals are outputted to a TV.

Therefore, the user can arbitrarily select the resolution regardless of whether the received video signal is HD class or SD class, or what terminal is connected to the TV, so that the resolution of the outputted video can be fixed at a resolution specified by the user.

For example, when the video receiving apparatus receives an HD class video signal, but a user selects a resolution of 480p, the resolution of the received video signal is changed to 480p and the changed signal is outputted.

Therefore, video may be outputted at a mis-matched resolution, and thus a user may be inconvenienced when having to re-set the resolution or when viewing the video at a mis-matched resolution.

### SUMMARY OF THE INVENTION

The present general inventive concept provides a method of automatically selecting a resolution, for example, in which the resolution with the highest image quality is automatically set even if a mis-matched resolution is selected, and provides a video receiving apparatus to use the same. Thus, a highest output resolution of the video receiving apparatus can be automatically matched to the highest resolution of a connected video display apparatus, which may be accomplished by converting an original input video signal to the appropriate matched highest resolution by the video receiving apparatus before being transmitted to the video display apparatus at the highest matched resolution.

The present general inventive concept provides a method of automatically selecting a resolution, in which the resolution, if mis-matched, is automatically changed (or adjusted, as needed) to a new resolution according to the type of connecting terminals connected to a video display apparatus and a signal is outputted at the new resolution, and provides a video receiving apparatus to use (or to be used in conjunction with) the same.

Additional aspects and advantages of the present general inventive concept will be set forth in part in the description which follows and, in part, will be obvious from the description, or may be learned by practice of the general inventive concept.

The foregoing and other objects and utilities of the present general inventive concept may be achieved by providing a method of automatically selecting a resolution, the method including determining whether an external apparatus is connected through a digital video output terminal, and automatically changing a resolution of a digital video signal outputted through the digital video output terminal if it is determined that the external apparatus is connected.

Specifically, the digital video output terminal may include a high definition multimedia interface (HDMI) terminal.

According to an exemplary embodiment, determining that the external display apparatus is connected involves detecting whether a predetermined voltage is applied to a specific pin of the digital video output terminal.

In this case, the predetermined voltage may be approximately 5V.

The changing (or adjusting, as needed) of the resolution may include determining a preset output resolution if it is determined that the external display apparatus is connected. At this time, if it is determined that the preset output resolution is not the highest resolution that can be supported, the resolution of the outputted digital video signal may be changed to the highest resolution that can be supported.

In the changing (or adjusting, as needed) of the resolution, the resolution of the outputted digital video signal may be matched to the highest preset output resolution that can be supported.

According to an exemplary embodiment, the highest resolution may be either 1080i or 1080p.

According to an embodiment of the present general inventive concept, a video receiving apparatus is provided, which includes a detector to detect whether an external display apparatus is connected to a digital video output terminal, a converter to change (or adjust, as needed) a resolution of a digital video signal outputted through the digital video output terminal according to the results of detection by the detector, and a controller to control the converter so that the resolution of the outputted digital video signal is changed (or adjusted, as needed) to match the resolution (e.g., the highest resolution or other resolution) supported by the external display apparatus if the external display apparatus is connected as detected by the detector.

According to an exemplary embodiment, the digital video output terminal may include a high definition multimedia interface (HDMI) terminal.

Specifically, the detector may be used to detect whether a predetermined voltage is applied to a specific pin of the digital video output terminal, and to output a detection signal to the controller if it is detected that the predetermined voltage is applied.

According to an exemplary embodiment, the controller may be used to conclude that the external display apparatus is connected if the detection signal is received from the detector.

In this case, the predetermined voltage may be approximately (or about) 5V.

According to an exemplary embodiment, the controller may be used to determine a preset output resolution if it is determined that the external apparatus is connected, and to control the converter so that the resolution of the outputted digital video signal is matched to the highest resolution that can be supported by the external display apparatus, if it is determined that the preset output resolution is not the highest resolution that can be supported.

According to an exemplary embodiment, the controller may be used to control the converter so that a resolution of the outputted digital video signal is outputted at the highest resolution that can be supported by the external display apparatus if it is determined that the preset output resolution is not the highest resolution that can be supported.

According to an exemplary embodiment, the highest resolution may be either 1080i or 1080p.

The foregoing and other objects and utilities of the present general inventive concept may be achieved by providing a method of adjusting automatically an output resolution of a video signal from a video output terminal, the method including adjusting automatically the output resolution to match a highest display resolution of a video display apparatus connected to the video output terminal.

The foregoing and other objects and utilities of the present general inventive concept may be achieved by providing a video apparatus to adjust automatically an output resolution of a video signal from a video output terminal, the apparatus including a controller to adjust automatically the output resolution to match a highest display resolution of a video display apparatus connected to the video output terminal.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram of a video receiving apparatus according to an exemplary embodiment of the present general inventive concept;

FIG. 2 is a block diagram of a video receiving apparatus according to another exemplary embodiment of the present general inventive concept; and

FIG. 3 is a flowchart regarding a method of automatically selecting a resolution of a video receiving apparatus according to an exemplary embodiment of the present general inventive concept.

Throughout the drawings, the same drawing reference numerals will be understood to refer to the same elements, features and/or structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In order to display digital broadcasts with the highest image quality, high definition multimedia interfaces (hereinafter, referred to as “HDMI”) have become available together with a method of connecting video display apparatuses to HDMI terminals providing HDMIs. HDMIs transmit digital video or audio signals by a single cable simultaneously, and have advantages such that digital signals can be transmitted without any losses. In other words, since image quality and tone quality of the signals transmitted to HDMIs can be maintained without loss. HDMIs are most suitable to obtain clear video, which is a main characteristic of HD broadcasts.

Using these characteristics of HDMIs, when a video receiving apparatus according to the present general inventive concept is connected to the video display apparatus through the HDMI terminal (which is a digital video output terminal), the video signal received (in its original received format and/or original received resolution) may be changed, adjusted or otherwise converted to match a highest quality resolution supported by the connected the video display apparatus before being transmitted to the connected video display apparatus, even if the video display apparatus resolution as selected by a user (for example) is mis-matched with the original received format and/or resolution thereof or the video display apparatus resolution is mis-matched with the output resolution of the HDMI terminal, according to one or more embodiments of the present general inventive concept.

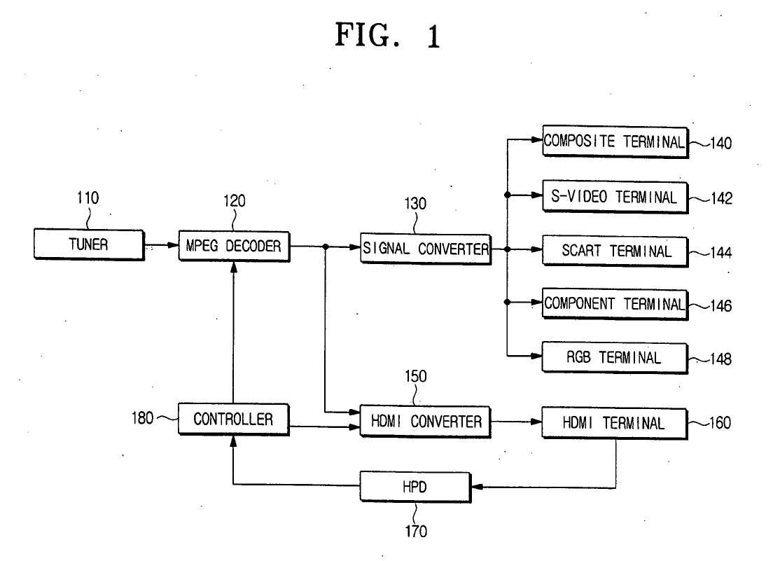

FIG. 1 is a block diagram of a video receiving apparatus according to an exemplary embodiment of the present general inventive concept.

In FIG. 1, the video receiving apparatus according to an exemplary embodiment of the present general inventive concept includes a tuner 110, a MPEG decoder 120, a signal converter 130, a composite terminal 140, a separate (S)-video terminal 142, a SCART terminal 144, a component terminal 146, a red-green-blue (RGB) terminal 148, an HDMI converter 150, an HDMI terminal 160, a hot plug detector (HPD) 170, and a controller 180, which may be connected as illustrated.

The tuner 110 can receive an external digital video signal and demodulate the received signal. The MPEG decoder 120 can decode the compressed digital video signal demodulated by the tuner 110.

The signal converter 130 can convert the digital video signal decoded by the MPEG decoder 120 to an analog video signal. Specifically, the signal converter 130 can convert signals to an analog form based on the type of connecting terminals available to output the converted analog video signal that may be connected to the video display apparatus.

In other words, when the video receiving apparatus is connected to the video display apparatus through the composite terminal 140 to output a composite video blanking sync (CVBS) signal, the signal converter 130 can convert the digital video signal decoded by the MPEG decoder 120 to a corresponding CVBS signal.

When the video receiving apparatus is connected to the video display apparatus through the S-video terminal 142 to output a luminance/chrominance (Y/C) signal, the signal converter 130 can convert the decoded digital video signal to the Y/C signal. When the video display apparatus is connected through the SCART terminal 144 to output an RGB signal, the signal converter 130 can convert the decoded digital video signal to an RGB signal.

Additionally, when the video receiving apparatus is connected to the video display apparatus through the component terminal 146 to output a YPbPr signal, the signal converter 130 can convert the decoded digital video signal to a YPbPr signal. When the connection to the video display apparatus is carried out through the RGB terminal 148 to output an RGB signal, the signal converter 130 can convert the decoded digital video signal to an RGB signal.

The composite terminal 140, S-video terminal 142, SCART terminal 144, component terminal 146 and/or RGB terminal 148 may be used as a connecting terminal to be connected to the video display apparatus, and to provide a transmission interface according to the type of output signal.

The HDMI converter 150 can convert the digital video signal decoded by the MPEG decoder 120 to a signal in a HDMI format to ensure the highest resolution. Specifically, when the video receiving apparatus is connected to the video display apparatus through the HDMI terminal 160 to output the output signal in the HDMI format, the HDMI converter 150 can convert the decoded digital video signal to a signal in an HDMI format.

The HDMI terminal 160 may be used as a connecting terminal to connect the video display apparatus, and to provide a high-definition multimedia interface to output the signal in the HDMI format. The HPD 170 can detect whether the HDMI terminal 160 is connected to the video display apparatus.

If, for example, the HPD 170 detects that the HDMI terminal 160 is connected to the video display apparatus, the controller 180 can determine that the video display apparatus is connected through the HDMI terminal 160. In this case, the controller 180 can control the HDMI converter 150 so that the digital video signal decoded by the MPEG decoder 120 is converted to a signal in a HDMI format having the highest resolution, for example.

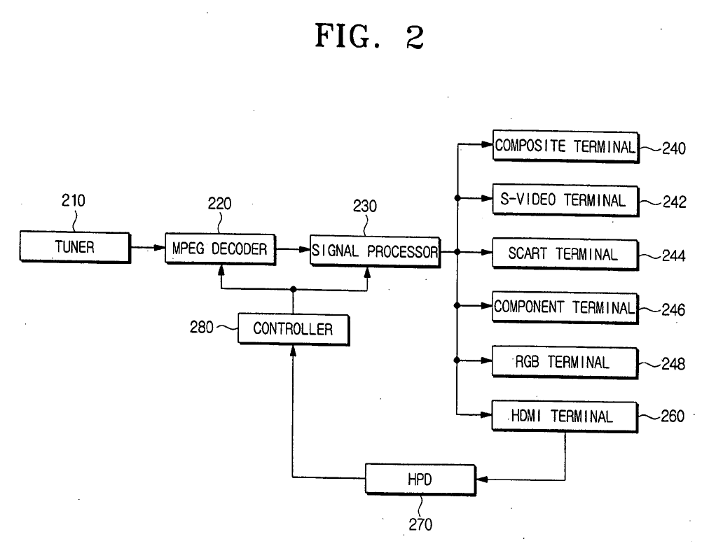

FIG. 2 is a block diagram of a video receiving apparatus according to another exemplary embodiment of the present general inventive concept.

In FIG. 2, the video receiving apparatus according to another exemplary embodiment of the present general inventive concept includes a tuner 210, an MPEG decoder 220, a signal processor 230, a composite terminal 240, a separate (S)-video terminal 242, a SCART terminal 244, a component terminal 246, a red-green-blue (RGB) terminal 248, an HDMI terminal 260, a hot plug detector (HPD) 270, and a controller 280, which can be connected as illustrated.

The tuner 210, MPEG decoder 220, composite terminal 240, S-video terminal 242, SCART terminal 244, component terminal 246, RGB terminal 248, HDMI terminal 260, HPD 270 and controller 280, described with respect to FIG. 2 correspond to the tuner 110, MPEG decoder 120, composite terminal 140, S-video terminal 142, SCART terminal 144, component terminal 146, RGB terminal 148, HDMI terminal 160, HPD 170 and controller 180 described in FIG. 1, respectively, and may be used to operate in the same manner as those corresponding terminals and components of FIG. 1, and accordingly their detailed descriptions (i.e., of the various corresponding elements of FIG. 2) are omitted.

The signal processor 230 (of FIG. 2) may be implemented by combining the signal converter 130 and the HDMI converter 150, as described in FIG. 1, and thus, the signal processor 230 (of FIG. 2) may have all the functions of the signal converter 130 (of FIG. 1) and of the HDMI converter 150 (of FIG. 1).

Thus, for example, if the HPD 270 detects that the HDMI terminal 260 is not connected to the video display apparatus, the signal processor 230 can convert the decoded digital video signal to an analog type signal according to the type of connecting terminal connected to the video display apparatus, and output the converted signal to the corresponding connecting terminal under the control of the controller 280.

On the other hand, if the HPD 270 detects that the HDMI terminal 260 is connected to the video display apparatus, the signal processor 230 can convert the decoded digital video signal to a signal in a HDMI format having the highest resolution, and output the converted signal to the HDMI terminal 260 under the control of the controller 280.

Embodiments of video receiving apparatuses according to the present general inventive concept may include all the various connecting terminals and converters and other components as illustrated and described with reference to the illustrations of FIGS. 1 and 2. However, video receiving apparatuses generally contain at least one terminal (e.g., or just one, two or three or a few terminals) selected from among the HDMI terminals 160 and 260, composite terminals 140 and 240, S-video terminals 142 and 242, SCART terminals 144 and 244, component terminals 146 and 246, and RGB terminals 148 and, 248, or some varying combinations thereof.

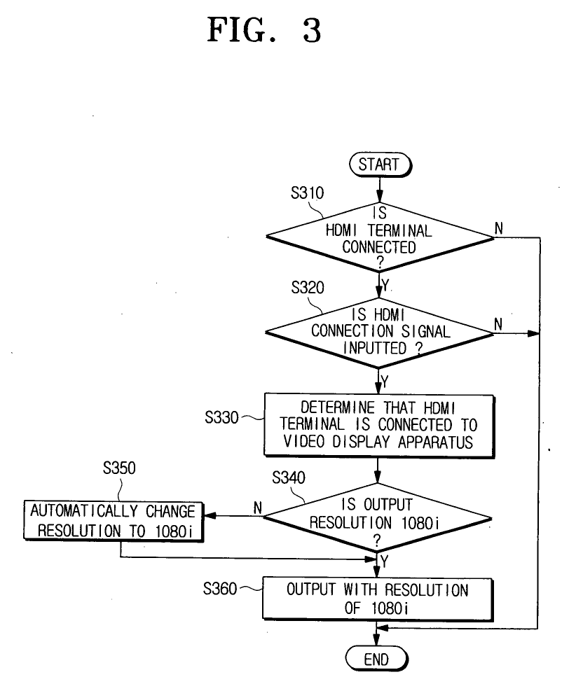

FIG. 3 is a flowchart explaining a method of automatically selecting the resolution of a video receiving apparatus according to an exemplary embodiment of the present general inventive concept.

Corresponding to FIG. 3, the HPD 170 can detect whether the HDMI terminal 160 is connected to the video display apparatus in operation S310. For example, if a voltage of 5V (or other suitable voltage or signal) is applied to a specific pin among a plurality of pins included in the HDMI terminal 160, the HPD 170 can detect that the HDMI terminal 160 is connected to the video display apparatus. If the voltage is not applied, the HPD 170 can detect (e.g., to determine or to ascertain) that the HDMI terminal 160 is not connected to the video display apparatus.

If it is detected (or determined) that the HDMI terminal 160 is connected to the video display apparatus in operation S310-Y, the controller 180 can determine whether an HDMI connection signal is inputted in operation S320. At this time, the HPD 170 can output an HDMI connection signal having a binary value of 1 to the controller 180.

If it is determined that the HDMI connection signal is received from the HPD 170 in operation S320-Y (e.g., to indicate that the HDMI terminal 160 is connected to a video display apparatus), the controller 180 can determine that the HDMI terminal 160 is connected to the video display apparatus in operation S330.

In addition, the controller 180 can determine whether a preset output resolution is the resolution with the highest quality, that is, 1080i in operation S340. The 1080i designation corresponds to a high quality resolution among HD class resolutions. Accordingly, the controller 180 can determine whether the preset output resolution is 1080i. Discussion of the 1080p resolution is separately described herein below.

If it is determined that the preset output resolution is not 1080i in operation S340-N, the controller 180 can control the HDMI converter 150 so that the resolution of the decoded digital video signal is converted to 1080i in operation S350. In the video receiving apparatus described in FIG. 2, the controller 280 can control the signal processor 230 so that the resolution of the decoded digital video signal is converted to 1080i in operation S350.

Additionally, the HDMI converter 150 can output the signal in the HDMI format having a resolution of 1080i which may have been converted under the control of the controller 180 to the video display apparatus through the HDMI terminal 160 in operation S360.

In operation S340, if it is determined that the preset output resolution is already at 1080i in operation S340-Y, the controller 180 can control the HDMI converter 150 so that the decoded digital video signal is outputted with a resolution of 1080i.

Also, in operations S340, S350 and S360, the resolution of 1080i may be replaced by a resolution of 1080p, though such resolution is not illustrated in FIG. 3. However, one of ordinary skill in view of the instant disclosure can readily replace the 1080i resolution recited in operations S340, S350 and S360 in FIG. 3 with the 1080p resolution to form a new flow chart essentially corresponding to FIG. 3 in all other aspects. The present general inventive concept includes such an embodiment.

In the exemplary embodiments described above, the HDMI terminal may be used to transmit video signals with the high resolution (e.g., 1080i or 1080p) as specified and described. However, other interfaces or components or terminals (as needed) can be utilized to transmit video signals with different high resolutions within the scope of the present general inventive concept.

As described above, according to the exemplary embodiments of the present general inventive concept, by maintaining the highest resolution of 1080i/p, it is possible to view broadcasts having optimum image qualities at all times when viewing digital broadcasts by connecting the video display apparatus through the HDMI terminal.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of automatically selecting an output resolution, the method comprising:
determining whether an external display apparatus is connected to accept the output resolution of a digital video output terminal; and
automatically adjusting the output resolution of a digital video signal outputted through the digital video output terminal to match a display resolution supported by the external display apparatus if it is determined that the external apparatus is connected.

2. The method as claimed in claim 1, wherein the digital video output terminal comprises a high definition multimedia interface (HDMI) terminal.

3. The method as claimed in claim 1, wherein in the determining, it is determined that the external display apparatus is connected if a predetermined voltage is applied to a specific pin of the digital video output terminal.

4. The method as claimed in claim 3, wherein the predetermined voltage is about 5V.

5. The method as claimed in claim 1, wherein the automatically adjusting comprises determining the output resolution, and adjusting the output resolution to match a highest display resolution supported by the external display apparatus if the output resolution does not match the highest display resolution.

6. The method as claimed in claim 5, further comprising:
transmitting the digital video signal at the output resolution matching the highest display resolution supported.

7. The method as claimed in claim 5, wherein the highest display resolution is either 1080i or 1080p.

8. A video receiving apparatus comprising:
a detector to detect whether an external display apparatus is connected to a digital video output terminal;
a converter to adjust an output resolution of a digital video signal outputted through the digital video output terminal if the detector has detected that the external display apparatus is connected to the digital video output terminal; and
a controller to control the converter to adjust the output resolution of the outputted digital video signal to match a display resolution supported by the external display apparatus if the detector has detected that the external display apparatus is connected to the digital video output terminal.

9. The apparatus as claimed in claim 8, wherein the digital video output terminal comprises a high definition multimedia interface (HDMI) terminal.

10. The apparatus as claimed in claim 8, wherein the detector detects whether a predetermined voltage is applied to a specific pin of the digital video output terminal, and outputs a detection signal to the controller if the detector detects that the predetermined voltage is applied.

11. The apparatus as claimed in claim 10, wherein the controller determines that the external display apparatus is connected through the digital video output terminal if the controller receives the detection signal from the detector.

12. The apparatus as claimed in claim 10, wherein the predetermined voltage is about 5V.

13. The apparatus as claimed in claim 8, wherein the controller determines the output resolution, and controls the converter to adjust the output resolution to match a highest display resolution supported by the external display apparatus if the output resolution does not match the highest display resolution.

14. The apparatus as claimed in claim 13, wherein the controller controls the converter to transmit the digital video signal at the output resolution matching the highest display resolution supported.

15. The apparatus as claimed in claim 13, wherein the highest resolution is either 1080i or 1080p.

16. A method of adjusting automatically an output resolution of a video signal from a video output terminal, the method comprising:
adjusting automatically the output resolution to match a highest display resolution of a video display apparatus connected to the video output terminal.

17. The method of claim 16, wherein the video output terminal is a high definition multimedia interface (HDMI) terminal and the highest display resolution is either 1080i or 1080p.

18. The method of claim 17, further comprising:
transmitting the video signal at the output resolution matching the highest display resolution.

19. A video apparatus to adjust automatically an output resolution of a video signal from a video output terminal, the apparatus comprising:
a controller to adjust automatically the output resolution to match a highest display resolution of a video display apparatus connected to the video output terminal.

20. The video apparatus of claim 19, wherein the video output terminal is a high definition multimedia interface (HDMI) terminal and the highest display resolution is either 1080i or 1080p.

21. The video apparatus of claim 19, further comprising:
a signal processor, wherein the controller controls the signal processor to adjust automatically the output resolution to match a highest display resolution of a video display apparatus connected to the video output terminal.

22. The video apparatus of claim 21, wherein the signal processor comprises a signal converter and a high definition multimedia interface (HDMI) converter.
